(19) United States
(12) Patent Application Publication
(10) Pub. No.: US 2013/0309641 A1
(43) Pub. Date: Nov. 21, 2013

(54) Systems and Methods for Assessing Behavioral Patterns and Promoting Behavioral Change by Comparing Gaming Performance to Aspirational Attributes

(71) Applicants: Benjamin G. Sawyer, Freeport, ME (US); Lynn E. Fiellin, New Haven, CT (US)

(72) Inventors: Benjamin G. Sawyer, Freeport, ME (US); Lynn E. Fiellin, New Haven, CT (US)

(73) Assignee: YALE UNIVERSITY, New Haven, CT (US)

(21) Appl. No.: 13/879,730

(22) PCT Filed: Oct. 24, 2011
(86) PCT No.: PCT/US11/57505

§ 371 Date: Aug. 9, 2013

Related U.S. Application Data
(60) Provisional application No. 61/405,810, filed on Oct. 22, 2010.

(51) Int. Cl. G09B 23/28

(52) U.S. Cl. CPC G09B 23/28
USPC 434/236

(57) ABSTRACT

Systems and methods are provided for assessing behavioral patterns and promoting behavioral change by comparing the performance of a user within a videogame or simulation to aspirational attributes (e.g., attributes defining an aspirational avatar) selected by the user in advance of the game, and conveying the results of the comparison to the user with video, graphics, text, audio, other media, or a combination thereof. The assessment can include guidance or suggestions regarding the need for behavioral modification and/or an identification of the user's choices that caused the user to attain, or fall short of the user's predefined aspirations.

### CROSS-REFERENCE TO RELATED APPLICATION

This application claims priority to U.S. Provisional Patent Application No. 61/405,810, filed Oct. 22, 2010, which is hereby incorporated by reference herein in its entirety.

### FIELD OF THE INVENTION

Embodiments of the present invention relate generally to computer systems and methods that assess behavioral patterns and promote behavioral change by comparing the performance of a user within a videogame or simulation to aspirational attributes (e.g., attributes defining an aspirational avatar) selected by the user in advance of the game, and conveying the results of the comparison to the user with video, graphics, text, audio, other media, or a combination thereof. The assessment can include guidance or suggestions regarding the need for behavioral modification and/or an identification of the user's choices that caused the user to attain, or fall short of, the user's predefined aspirations.

### BACKGROUND OF THE INVENTION

Discovering new ways to teach children and other individuals core values, good health practices, and life lessons is of critical importance. Instilling within an individual the ability to make informed and healthy decisions can be the difference between that individual thriving, or not, both socially and professionally. While the need to educate children and other individuals is the subject of considerable attention, the ways to convey important lessons to them are relatively few.

In one approach, computers have been introduced into classrooms and homes to serve as educational tools. The reason is at least twofold. Computer literacy is becoming increasingly necessary in order to achieve success in many areas of today's business environment. In addition, many individuals enjoy using computers and do so in their everyday lives, thus pointing to computers as an effective means to captivate their interest and provide a forum within which they can learn. Captivating an individual's interest through computer use is not enough, however, since the message resulting from such usage must be educational and must resonate with the individual for it to be effective as an educational tool.

Conventional computer games and applications attempt to provide educational value through a number of methodologies. Some computer applications drill and teach to traditional subjects such as math and grammar, but do not address behaviors, values, health practices, and other life lessons that are also important in the development of a child or other individual. In addition, such computer applications are frequently disliked by users because they are overtly educational and can be difficult to navigate, especially for individuals who are struggling with the very subjects the computer applications are intended to address.

Other videogames have the potential to convey life lessons to players but the entertainment aspect of the game is the primary focus and any learning or educational value is only secondary. Players participate and compete for status (e.g., virtual rank, wealth, material possessions, etc.) as their primary objective, while educational value is conferred only implicitly, if at all, as the players learn the rules and constraints of the game within which they must operate. Ian Bogost, The Rhetoric of Video Games, The Ecology of Games: Connecting Youth, Games, and Learning, MIT Press, 2008, pp. 117-140, which is hereby incorporated by reference herein in its entirety. The rules and constraints of the game can teach valuable lessons, but only if the player perceives and is receptive to the underlying educational message, and if the player recognizes its relevance within the player's real life. For example, in one game, a player must perform various tasks repeatedly in order to earn enough in-game currency to purchase virtual items, pay down the mortgage on the player's virtual home, or purchase a new virtual home Implicit within this process are potential lessons about long-term debt and the financial burden that comes with the desire for material possessions. However, these lessons are only learned if the player chooses to think more broadly about the rules and constraints of the game and how they could potentially translate into scenarios within the player's real life, instead of mindlessly and linearly plodding through the game to try to achieve the best score or status to earn bragging rights within the multi-player game.

Yet another type of videogame attempts to teach good habits and behaviors by linking a player's in-game abilities or performance (e.g., super-powers) to behavioral aspects of the player's real life. The theory is that the player's desire to have better in-game performance will cause the player to make better real-life decisions. For example, U.S. Pub. No. 2009/0325701, published on Dec. 31, 2009 for a “Gaming System” and incorporated herein by reference in its entirety, allows a moderator such as a teacher to change the appearance and/or performance of a player's in-game avatar based on whether, in real life, the player currently spends enough time doing homework assignments, refrains from smoking cigarettes, or exercises regularly.

Similarly, U.S. Pub. No. 2008/0146334, published on Jun. 19, 2008 for a “Multi-Player Role-Playing Lifestyle-Rewarded Health Game” and incorporated herein by reference in its entirety, alters in-game execution based on the real-life health behavior of a user. The user wears or interacts with sensors that measure caloric intake and exercise levels, and the system manipulates in-game performance to reward good health behaviors. The system allows the user to create an avatar and profile that mimics the realities of the world in which the user actually lives, and equips the player's avatar with supplies, weapons, etc. as a reward for the user currently engaging in favorable real-life activities. Underlying this approach is the assumption that the player will enjoy and respond favorably to a game wherein the user's in-game avatar and profile are tied to the immediacies of the player's real life. However, what can happen instead is that the player loses interest because the game is too cumbersome or intrusive due to the need to wear or interact with sensors, too overtly educational, or too judgmental since the player's in-game performance is tied to the player's current, real-life decisions.

In view of the foregoing, what is needed is an improved system and method for teaching good behaviors and promoting behavior modification through computer gaming or simulation. For example, it would be desirable to provide a system and method that go beyond and/or provide alternatives to the aforementioned approaches that focus on manipulating the player's in-game appearance or capabilities, for example, as rewards for real-life behavior.

### SUMMARY OF THE INVENTION

Embodiments of the present invention provide systems and methods for assessing behaviors and promoting behavioral change. Performance of a user (e.g., child, teen, or adult) within a videogame or simulation is compared to aspirational attributes selected by the user in advance of the game, and the user is provided with an assessment of the user's performance along with suggestions and/or guidance for behavioral change. In some embodiments, the systems and methods provided herein help users to learn and understand how various choices can affect their real-life aspirations, causing them to meet or fall short of their future goals. Although an intended result according to some embodiments of the present invention is for the user to learn core values, good health practices, and/or other life lessons that are applicable within the real world, some embodiments of the present systems and methods accomplish this goal via a purely fantastical virtual game or simulation without the need to link in-game performance or capabilities to the user's current, real-life decisions. The systems and methods provided according to some embodiments of the present invention can also provide the user with an assessment that contains concrete lessons, in contrast to videogames wherein any educational value is only secondary and at most implicit.

In some embodiments of the present invention, computer systems and methods are provided that allow a user to define aspirational attributes in the form of goals or desires for the future. A computer game or simulation is also provided that presents virtual scenarios to the user that test and assess various behaviors expressed by the user. Depending on the user's choices within these scenarios, the present systems and methods generate and convey to the user an assessment of whether the user will attain (e.g., did attain within the virtual game or simulation or will likely attain in the real world), fall short of, and/or exceed the user's predefined aspirations. The opportunity to define aspirational attributes via the computer system, the computer game or simulation, and the assessment of the user's performance can be provided to the user using any suitable computing approach or combination of approaches including, for example, a videogame presented through the use of a videogame console (e.g., Xbox 360®) or other personal or home computer, a mobile phone game or simulation (e.g., application operating on a smartphone), social networking game or simulation (e.g., made available via an online interface accessible by a user computer), or other computer platform or combination of computer platforms.

According to some embodiments of the present invention, a system, method, and non-transitory computer-readable medium are provided for assessing behavioral patterns and/or promoting behavioral change. Computer memory (e.g., one or more databases) is provided that stores options available to a user to define one or more aspirational attributes relating to the user's future family life, social life, career, education, health, economic status, or other goal for the future. In some embodiments, the options related to the user's family or social life or career include one or more options related to the lives of close family member(s) or others (e.g., friends, employees, or pets) the user's own life could have a significant impact on (e.g., an option to define an aspiration to serve as a primary caregiver in the future for an aging parent). The options may be stored, for example, in the form of a template that contains user-selectable options (e.g., options selectable via drop-down menus or check-boxes). A computer system (e.g., including one or more processors) in communication with the computer memory is also provided. The computer system is configured to provide a graphical user interface for display to the user, the graphical user interface for displaying the options available to the user to define the user's one or more aspirational attributes. The computer system is also configured to receive, based on the user selecting from the one or more options, the user's one or more aspirational attributes, as well as data relating to one or more choices made by the user within a computer game or simulation. According to some embodiments, the choices made by the user within the game or simulation have a defined relationship to the user's one or more aspirational attributes (e.g., the choices being indicative of and configured to cause an increase, or decrease, in the likelihood that the user will attain the user's desired attributes). The computer system is configured to generate an assessment of whether the user will attain (e.g., did attain within the virtual game or simulation or will likely attain in the real world) the user's one or more aspirational attributes based on the choices made by the user within the computer game or simulation, and to provide the assessment (e.g., including video, graphic(s), text, and/or audio) for display to the user.

In some embodiments, the assessment includes an identification of the one or more choices from within the game or simulation that caused the user to attain, or fail to attain, the user's one or more aspirational attributes within the game or simulation. In some embodiments, the assessment includes an identification of one or more attributes that are degraded relative to the user's one or more aspirational attributes as a result of the user's choices.

In some embodiments of the present invention, the computer memory may store a user profile that includes a value for each of the user's one or more aspirational attributes, and the computer system may be configured to provide these values to a computer application that provides the computer game or simulation. During and/or subsequent to the computer game or simulation, the computer application may provide the computer system with data identifying whether the value for each of the user's one or more aspirational attributes has been modified by the computer application based on the choices made by the user within the computer game or simulation. Based at least in part on this data, the computer system may generate and provide the assessment of the user's performance to the user.

In some embodiments, the options available to the user to define the user's one or more aspirational attributes include (e.g., consist or consist essentially of) options to create an avatar. The computer system may be configured to provide the avatar to the computer application for use within the computer game or simulation. In some embodiments, the computer application may be configured to alter the display of the avatar and/or any other visual or media (e.g., multimedia) embodiment of the user's defined aspirations within the computer game or simulation (e.g., during and/or after completion of the game or simulation) based on one or more of the choices made by the user within the game or simulation. Such visual or media embodiment of the user's defined aspirations may include, for example, icon(s), other graphic(s) (e.g., photographs), video, and/or text representing one or more of the user's defined aspirational attributes.

In some embodiments of the present invention, the computer application may tailor or customize one or more of the scenarios presented to the user within the computer game or simulation based on the user's one or more aspirational attributes. For example, if the user's aspirational attributes indicate a desire to own an expensive house in the future, the computer application may present the user with scenario(s) that could derail that aspiration if the user does not make appropriate choice(s). In some embodiments, the computer application may allow the user to further define the user's one or more aspirational attributes during the computer game or simulation, for example, by allowing the user to provide a label corresponding to the user's one or more aspirational attributes (e.g., allowing the user to define that “Arizona State” is the institution corresponding to the user's predefined aspiration to attend a university). In some embodiments, the computer application may provide these label(s) to the computer system so that the labels can be displayed for the user as part of the assessment of the user's performance.

### BRIEF DESCRIPTION OF THE DRAWINGS

For a better understanding of the present invention, reference is made to the following description, taken in conjunction with the accompanying drawings, in which like reference characters refer to like parts throughout, and in which:

FIG. 1 is a block diagram of a system for assessing behavioral patterns and promoting behavioral change in accordance with an embodiment of the present invention;

FIGS. 2-3 are screen shots of illustrative displays that may be provided in order to allow a user to define one or more aspirational attributes according to some embodiments of the present invention; and

FIG. 4 is a flowchart of illustrative stages involved in assessing behavioral patterns and promoting behavioral change according to some embodiments of the present invention.

### DETAILED DESCRIPTION OF THE INVENTION

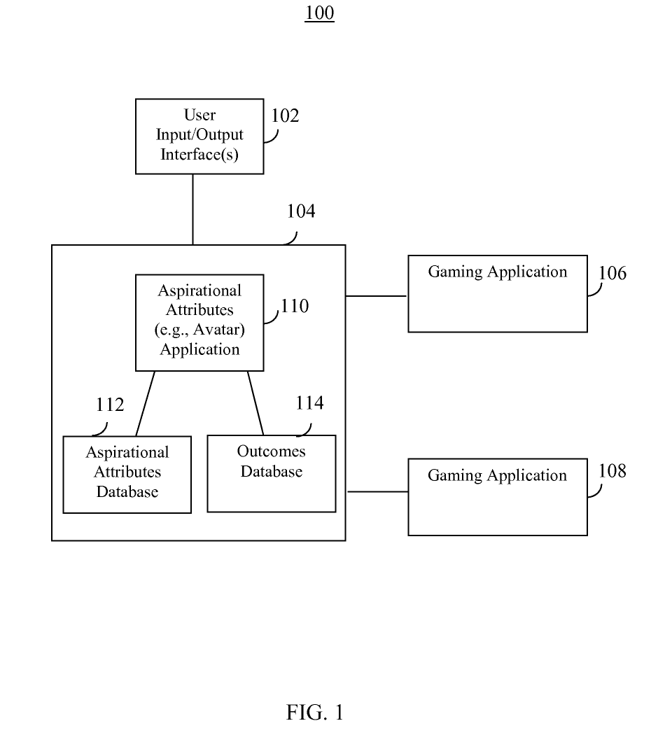

Embodiments of the present invention relate to systems and methods for promoting behavioral modification through the use of a computer game or simulation and a corresponding assessment of whether a user is likely to attain future goals given the choices (e.g., representative of risky behavior) made by the user in the game. FIG. 1 is a block diagram of a system 100 for assessing behavioral patterns and promoting behavioral change in accordance with an embodiment of the present invention. System 100 includes user input/output interface(s) 102, aspirational attributes computer system 104, and gaming or simulation applications 106 and 108. Applications 106 and/or 108 may be in communication with system 104 via any suitable communications connection(s) or configuration. In some embodiments, applications 106 and/or 108 may reside on the same one or more computers as system 104 (e.g., personal computer or mobile phone). In other embodiments, each of applications 106 and/or 108 may communicate with system 104 via one or more servers. Such communications may be enabled by a suitable communications capability such as, for example, an internet connection (e.g., over cable, satellite, or fiber optics), a local area network (LAN), or any other suitable wired, wireless, or optical connection, or a combination thereof. Applications 106 and/or 108 may include any suitable hardware (e.g., one or more processors), software, or combination thereof for allowing a user, or multiple users within a multi-player game, to engage in a computer game or simulation and/or for interfacing with system 104 in the manner described below.

User input/output interface(s) 102 may include any suitable computer equipment for receiving inputs from a user and providing those inputs in computer-readable form to system 104. For example, in some embodiments, interface(s) 102 may include a computer keyboard, mouse, voice recognition device, remote control, joystick, gamepad, camera-based gesture recognition device (e.g., Kinect for Xbox 360®), and/or any other suitable user input device(s). In some embodiments, the same, or different, user input device(s) may receive inputs from the user and provide those inputs in computer-readable form to gaming applications 106 and/or 108.

In some embodiments, interface(s) 102 also include suitable equipment for providing outputs from system 104 and/or applications 106 and/or 108 to the user. Such interface(s) may include one or more display devices (e.g., liquid crystal display (LCD) device of a personal or home computer, a mobile phone display, or the display of a handheld videogame apparatus), one or more audio devices (e.g., one or more speakers), and/or any other suitable output device(s).

Aspirational attributes system 104 may include aspirational attributes application 110, aspirational attributes database 112, and outcomes database 114. Application 110 may include any suitable hardware (e.g., one or more processors), software, or combination thereof for providing a user with options (e.g., via a graphical user interface displayed by interface(s) 102) to define future goals, for generating and providing the user with an assessment of whether or not the user will attain those goals based on choices made by the user within gaming applications 106 and/or 108, and/or for interfacing with gaming applications 106 and/or 108 in the manner described below. For example, in some embodiments, application 110 may provide the user with options to define one or more aspirational attributes relating to the user's future family life, social life, career, education, health, economic status, or other goal for the future. In some embodiments, application 110 may allow the user to create an aspirational avatar for subsequent use within gaming applications 106 and/or 108. In some embodiments, application 110 may reside, at least in part, on the user's smartphone, personal, home, or school computer, or other computer (e.g., on a server in communication with a user computer).

Aspirational attributes database 112 may store data indicative of the options available to a user of application 110 to define one or more aspirational attributes. Alternatively or additionally, database 112 may store an aspirational profile for the user indicative of the particular aspirational attributes selected by the user (e.g., avatar definition if the profile will be used, at least in part, to represent the user's avatar in gaming application 106 and/or 108).

Outcomes database 114 may store data indicative of various permutations or gradients of the user's aspirational profile, or aspirational avatar, that could result depending on choices the user makes within gaming applications 106 and/or 108. One or more of these outcomes can be provided (e.g., displayed) at least in part to the user, for example, by application 110 when the user has completed the computer game or simulation provided by application 106 or 108, application 110 has received from application 106 or 108 data indicative of the choices made by the user during the game or simulation (e.g., data indicative of risky or unfavorable behavior(s)), and application 110 generates an assessment of the likelihood that the user will attain the user's aspirational attributes in view of the user's in-game choices. In other embodiments, application 106 and/or 108 can generate and/or provide the assessment to the user, for example, using the outcomes stored in database 114 (e.g., application 106 and/or 108 receiving data regarding the outcomes from application 110 or directly via communication with database 114). In some embodiments, the assessment provided to the user can provide explicit guidance and/or implicit suggestions regarding how the user can modify various behaviors. The assessment (e.g., including outcome(s)) can be conveyed to a user using any suitable media including, for example, video, graphic(s) (e.g., still or animated), audio, and/or text.

In some embodiments, databases 112 and/or 114 may reside on the same computer system (e.g., personal or home computer or mobile phone) as application 110 and/or applications 106 and/or 108. Other system arrangements are also possible and are fully contemplated as being within the scope of the present invention. For example, for an internet-based or multiple-player gaming platform, aspirational attributes application 110, the gaming application (e.g., 106 or 108) currently being accessed by the user, and/or databases 112 and/or 114 may be accessible via or may operate on, at least in part, one or more remote servers. In such a configuration, the user's computer can function as a client that provides the necessary inputs/outputs 102 from/to the user. In some embodiments of the present invention, application 110, application 106, and/or application 108 are part of the same hardware, software, or combination thereof.

In some embodiments, aspirational attributes system 104 extends the notion of a computerized embodiment of a user (commonly, referred to as an “avatar”) by having the user define a set of aspirational traits of life. By capturing aspirational or future goals in an avatar definition context, as an act of configuring a representation of the user's character prior to engaging a game, virtual world, or other interactive software application, compatible or integrated software systems (e.g., applications 106 and/or 108), mostly orientated toward entertainment, health, and education, can better tailor the user experience to improve potential real-world behavior change outcomes. This is in contrast to existing videogame and software application avatars that are essentially physically-defined embodiments of a player in a game or application, defined in physical appearance terms, where typically the players/users merely construct avatars that look like themselves.

According to some embodiments of the present invention, system 104 allows the user to define an aspirational avatar that embodies one or more of the user's future life and personal goals. These goals can include desires of life in fictional/fantasy and/or realistic form. The created aspirational avatar can enable applications 106 and/or 108 to create motivation for users to complete and excel at a software process or puzzle by linking the outcome of that effort to fulfillment of a user's intended future life. This can be further enhanced by providing (e.g., by system 104 or applications 106 and/or 108) the user with an assessment of the user's in-game performance and guidance or suggestions for behavioral change at various point(s) throughout the game or simulation and/or once the game or simulation is complete. The aspirational avatar can act as a motivational tool to help deepen a user's experience with a game or other piece of software while improving the user's ability to orient themselves toward meaningful real-life behavior change. In some embodiments, during and/or subsequent to completion of the game or simulation, applications 106 and/or 108 may alter the user's avatar and/or any other visual or media (e.g., text, graphic(s) including one or more icon(s), photograph(s), multimedia, etc.) embodying aspects of the user's defined aspirations based on one or more of the choices made by the user within the game or simulation. This can apprise the user of the user's progress, or lack of progress, towards attaining those aspirations (e.g., conveying via icon(s), other graphic(s), photograph(s), and/or text during and/or subsequent to completion of the game or simulation that the user is, or is not, on track to attain their desired level of income, career choice, house, and/or ability to interact or care for with other individual(s) in the user's life).

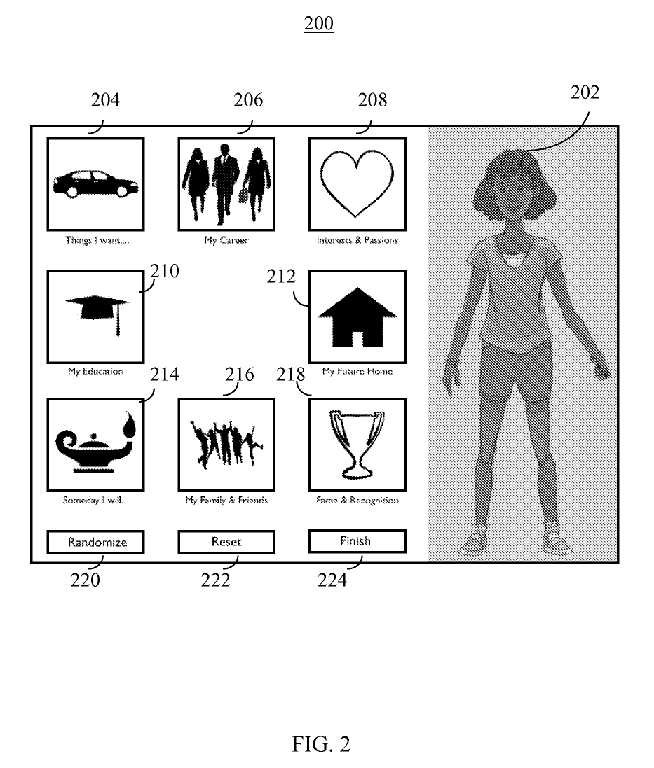

In some embodiments, although the aspirational attribute definition (e.g., definition of an aspirational avatar for use within a game or simulation) provided by system 104 may not be a game or simulation unto itself, it can be an entertaining precursor to a game or application process, and also can be educational, although not overtly educational in some embodiments. System 104 can provide the players or users with an opportunity to make connections between their probably nebulous desires—e.g., “wealth,” “frame,” “success” and more concrete accomplishments, getting them thinking first about what they want, and then later what they should achieve and potentially value in their life. In some embodiments, the user may be provided with one or more options to define aspirations for offspring, kin, a spouse, other significant life partner(s), employee(s), other individual(s) the user is or would like to be close to or interact with, and/or pet(s) since, for example, behavioral lessons and/or change can be tied to the realization that the user's life choices also significantly affect the user's aspirations relating to these individual(s) and/or pet(s). For example, the user may be provided with option(s) to upload photograph(s) of individual(s) or pet(s) which are the subject of the user's aspirational attributes. By cultivating this input in an aspirational attributes configuration mode motif (e.g., FIG. 2), what is created is a powerful computational set of information that can be used to motivate play, and provide reflection and scaffolding for offline behavior change by an individual. In various embodiments, the information extracted by system 104 can be used to provide negative and/or positive message framing to develop strong communication bonds with a player or user during, or upon completion of, a computer game or simulation.

According to some embodiments, an aspirational avatar or set of attributes defined through system 104 is not just who the user is in the present—it's about who they want to be at some point in their future and may include, for example, their ability to affect the lives of those they are closest to including offspring, kin, a spouse, other significant life partner(s), employee(s), other individual(s) the user is or would like to be close to or interact with, and/or pet(s). Creating that differential in a data structure form allows for computational and procedural interaction. For example, this computational structure allows for applications and games (e.g., applications 106 and/or 108) to utilize procedural rhetoric to a more powerful extent, giving them enhanced capability to use rules, constraints, and outcomes from interactive decisions to create new forms of persuasive rhetoric. For example, in some embodiments, applications 106 and/or 108 may tailor the scenarios presented to the user during a simulation or game based at least in part on the user's aspirational attributes from system 104 (e.g., presenting the user with scenario(s) that could affect the user's ability to earn a high income if the user expressed via system 104 a desire to own an expensive car or home in the future). To that end, in some embodiments, some implementations of system 104 can provide strong benefit for applications 106 and/or 108 (e.g., software) that seek to utilize high-level interactivity and behavior change mechanics to help people with education, health, financial, and other habit-changing goals. Applications 106 and/or 108 can impose rules and constraints on the user in the game or simulation (e.g., as in above-incorporated Bogost, The Rhetoric of Video Games, The Ecology of Games: Connecting Youth, Games, and Learning), with the improvement that applications 106 and/or 108 can interface with system 104, for example, to provide scenarios tailored to the user's aspirational attributes from a collection of scenarios accessible to applications 106 and/or 108 and/or to generate, or assist in generating, an assessment of the likelihood that the user will attain those aspirations (e.g., the assessment containing guidance or suggestions for behavioral change).

The aspirational attributes selected by a user may in some embodiments provide on an emotional level a chance for players/users to feel like life is filled with possibilities if they can just provide a bit of definition to them. In some embodiments, system 104 never says “no” outright nor provides explicit judgment when the user selects aspirational attributes. Rather, any form of judgment whether explicit or implicit may be reserved for inclusion within the assessment provided to the user as a byproduct of the choices made by the user in the virtual game or simulation after the user's initial goal definition. During setup, the interface provided by 104, the choices available, plus people's everyday perceptions can provide a strong sense of calibration to the goal-setting process, getting the user thinking about the right things (e.g., family, health, career, etc.). In some embodiments, system 104 has the effect of advocating to others and the users/players themselves, that they plan, define, declare and express goals and desires as a key means of achieving them. System 104 (e.g., application 110) can do this by celebrating those definitions by providing a visual interface to explore and set them. One goal according to some embodiments of the present invention is for players/users of system 104 to feel not only agency over their aspirations but also celebration over the ability to be in a “world” or a space where stating their desires (be they realistic and/or fantastical) is entirely encouraged, and respected—even if the ultimate premise is to see how well the user can realize those goals given subsequent choices made in a game or simulation.

In some embodiments, once the user has defined aspirational attributes, applications 106 and/or 108 utilize this data (e.g., stored in database(s) 112 and/or 114) to provide contextual message framing and/or risk scenarios in the context of a game or application. Analysis of the user's choices within those scenarios may be performed by applications 106 and/or 108, or by system 104 based on data returned to system 104 by applications 106 and/or 108.

In some embodiments, the aspirational attributes collected by system 104, and/or by applications 106 and/or 108 upon further definition during performance within the game or simulation, are not affected by outside actions taken by the player in the real-world (e.g., user's in-game aspirational avatar is not awarded additional supplies or powers based on whether the user in real life does his/her homework, practices good health behaviors, or exercises regularly). In some embodiments, such aspirational attributes are not linked to biometrics, caloric sensors, third-party assessments, or real-world events. In some embodiments, they do not involve sensor data that changes avatar choices or capabilities. This is in contrast to and represents a fundamental departure from conventional systems that meld real-world data with in-game avatars where the behaviors of the user in the real-world affect the in-game avatars graphical display or its abilities within the game (e.g., jumping higher due to better real-world health performance).

In some embodiments, an aspirational avatar may be provided (e.g., by system 104) that is essentially a data-model housed in a computer, Web, or embedded software application that can be designed by the user via a software interface that lets them textually, and/or graphically, define life-plans for themselves or a fictional character they plan.

According to some embodiments, the computer system and/or method provided herein automatically assigns specific behind-the-scenes data values to those life plans (e.g., desired outcomes). Subsequently, play or application decisions in a game or application can degrade or improve those outcomes for the player. The data values may be stored in a computer readable file or database system that can be referenced by the requesting application (e.g., applications 106 and/or 108) from which that application can then perform logical operations relevant to the choices made by the user in the game or simulation.

In some embodiments, once a final end-state is achieved (e.g., and/or throughout gameplay) the computer system and/or method may store a modified set of data that is compared to the original aspirational attributes selected by the user/player. In some embodiments, such a comparison enables the system and/or method to specifically show the user what choices they made during play/application use that led to the realization, degradation, or even surpassing of their originally-defined aspirational life-plans (e.g., messages indicating that the user should aim high and not sell himself/herself short). Such a result, coupled with the creation of a life-plan and application interaction, is theorized to assist with behavior change/modification of users. As users are exposed to how choices can have an effect on their various life plans including wealth, health, family planning, frame, recognition, material goals, and other goals, they can begin to experience the relationship between these decisions and their aspirational goals in terms of, for example, rhetorical messages on screen and/or procedural rhetoric that is experienced in the form of gameplay rules and results or application features and results.

FIG. 2 is a screen shot 200 of an illustrative aspirational attributes definition display that may be displayed (e.g., via an interface provided by application 110) in order to allow a user to define one or more aspirational goals according to some embodiments of the present invention. In some embodiments, definition of aspirational attributes may include the creation of a physical avatar 202, for example, since gamers are commonly accustomed to having an avatar during a game or simulation. In some embodiments, however, aspirational attributes (e.g., regarding qualities of life) enabled via the display can be depicted in different manners than a humanoid form. For example, aspirational attributes can be provided as a textual list or a textual list with accompanying graphics and icons in the display and/or in the game or simulation provided by applications 106 and/or 108.

In some embodiments, display 200 may include option 204 to define attribute(s) regarding the things (e.g., possessions such as car(s)) the user wants in life, option 206 to select attribute(s) regarding a future desired career, option 208 to define attributes regarding the user's interest(s) and/or passion(s), option 210 to define attributes regarding the type of and/or where the user desires to receive an education, option 212 to define attributes regarding the user's desired future home, option 214 to define attributes regarding what the user hopes to someday accomplish and/or do, option 216 to define attributes regarding the user's family and/or friend(s), and/or option 218 to define attributes regarding desires about future frame and/or recognition. In some embodiments, display 200 may include option 220 to randomize the order of the options displayed, and/or to make automatic selections of attributes for the user from one or more of the available options. Display 200 may include option 222 to reset the selections from the available options, for example, back to no selected values or default or random values. Display 200 may include option 224 to finish the aspirational attribute definition (e.g., selection of which may cause system 104 to store aspirational attributes for the user in database 112).

In some embodiments, aspirational qualities may be divided into categories with easy to use wizards that help the user define specific goals in life. The goals may be divided amongst life plans (e.g., career), material wants (e.g., clothes), passions & interests (e.g., hobbies), wishful fantasies (e.g., to meet a famous person), points of emphasis (where to spend most of my time and energy), and other factors such as frame and recognition. The options shown in FIG. 2 are only illustrative and any other suitable options may be provided in accordance with other embodiments of the present invention. For example, and without limitation, options may be provided that allow the user to specify the following desired outcomes with respect to major life decisions that people often consistently review and revise with realism and/or fantasy:

What career do I want?

When do I expect to be married and/or have kids?

What kind of car will I own?

Where will my children go to college?

Will I live to see my grandchildren?

How much will I be able to care for an aging parent as a primary caregiver?

Where will I go to college? or tradeschool? or join the army?

Where will I live?

How much do I want to weigh?

What are my salary goals?

What hobbies do I wish to have in life?

What is a place I must visit just once in my life?

What famous person do I wish to meet?

In some embodiments, each specific aspirational attribute selected by a user may be specifically noted (e.g., coded by system 104 and stored in database 112) so that there is clear understanding of how to address the player about it later in the game or application (e.g., provided by applications 106 and/or 108).

According to some embodiments of the present invention, definition of aspirational attributes (e.g., creation of an aspirational avatar) via the present systems and/or methods may achieve one or more of the following goals:
1. Improve users/players (especially youth, a primary target of the approach) a credible, guided and interesting means to think and visualize over what they want from life beyond next week or other short-term periods.
2. Raise the stakes for making short term decisions that compromise long or even medium term goals. This can involve in-application/game decisions, and the goal is that it will act as an impetus to shape real-world decisions as well. By motivating players/users to invest time in an aspirational attribute definition, and gaming or simulation that draws upon and/or tests the foundation of those desired attributes, the present systems and methods can draw on that investment and personal sunk cost by the user/player to generate new forms of intrinsic and extrinsic motivation.

In some embodiments, each of the selections made by a user in an aspirational avatar definition context results in a uniquely understood variable within a game or application, as reflected in the rules and constraints and scenarios presented to the user (e.g., by applications 106 and/or 108). For example, if a user indicated that he/she wanted to have a house, they could be presented with choices via applications 106 and/or 108 that might affect the outcome of where they wanted to live or how expensive of a house they could afford. For example, if a player made a poor choice of income strategies they might see an end-state that falls short of their aspirational goals of a large mansion on the water in Hawaii.

In some embodiments, standardized choices from which the user can select could be employed to customize a game's overall look and feel to create a more personal look to the game. For example, a person who chooses a desired occupation involving science might see within the game or simulation scenes that take place in chemistry labs or meet colleagues in lab jackets whereas a person who choose a performing arts career might see scenes take place in auditoriums and stages and meet colleagues who had musical instruments or were putting on costumes and makeup. These aesthetics can be important to raise notions of self efficacy in a game setting and drive home points the game or application is making.

According to some embodiments, the present systems and/or methods provide a layer of data and computer-executable instructions that allow for the creation of customized aspirational avatars and/or attribute sets for use by any game or application, and/or computer-executable instructions for generating, querying, and utilizing resulting messaging and design aesthetics to promote behavioral change. In some embodiments of the present invention, the present systems and/or methods may include one or more application programming interfaces (APIs) that allow any number of requesting applications (e.g., applications 106 and/or 108) to request and utilize the aspirational attributes and/or avatar created by the user via system 104. For example, an API may be provided that specifies the manner in which an application can receive aspirational attribute data, process and/or modify it during a game or simulation, and process the results (e.g., communicate modified data back to system 104) in order to allow for the generation of an assessment (i) of how the user's in-game performance compares to his/her aspirational attributes and/or (ii) providing suggestions or guidance for behavioral change.

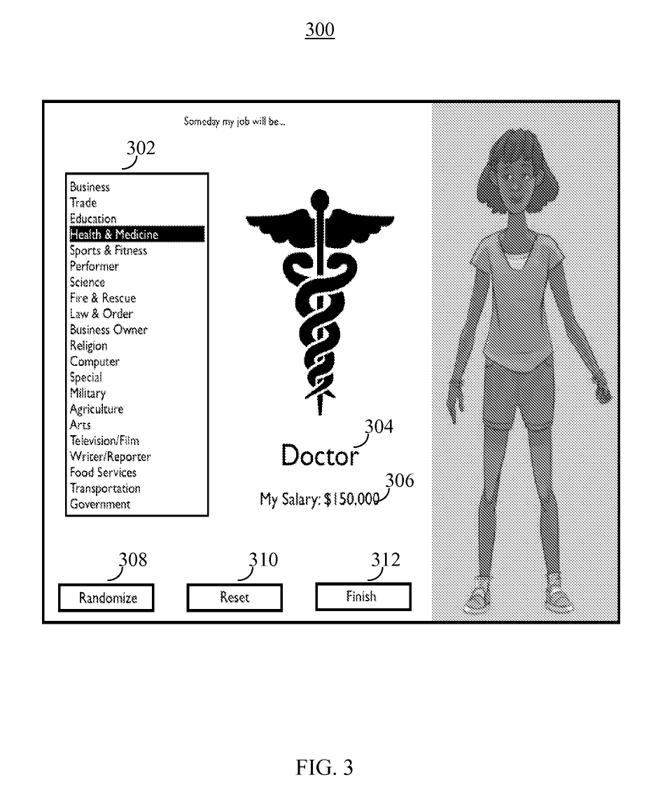

FIG. 3 is a screen shot 300 of another illustrative aspirational attributes definition display that may be displayed to a user according to some embodiments of the present invention. For example, display 300 may be a sub-display that is provided (e.g., by application 110) for display to the user in response to a user selection of option 206 from display 200 (FIG. 2). Display 300 may include categories of professions 302 (e.g., business, trade, education, health & medicine, sports & fitness, performer, science, fire & rescue, law & order, business owner, religion, computer, special, military, agriculture, arts, television/film, writer/reporter, food services, transportation, and/or government), and/or professions 304 (e.g., doctor), that can be selected as aspirational attributes by the user. Other information, such as projected or desired salary 306 (e.g., “$150,000”) may also be provided (e.g., provided as a result of the user's selection of a profession), or able to be defined by the user. In some embodiments, display 300 may include option 308 to randomize the order of the options displayed, and/or to make automatic selections of attribute(s) for the user from one or more of the available options. Display 300 may include option 310 to reset the selection(s) from the available options, for example, back to no selected values or default or random values. Option 312 may also be provided to finish the aspirational attribute definition within display 300 (e.g., selection of which may cause system 104 to return the display to screen 200 in FIG. 2 or other display screen). In some embodiments, each of displays 200 (FIG. 2) and 300 (FIG. 3) may include any suitable combination of video, graphic(s) (e.g., still or animated), audio, text, and/or other media.

According to some embodiments of the present invention, systems and methods are provided that enable distinct modules of activity/interactivity by the user—each of which can contribute to the realization of the user's desires and subsequent actions toward obtaining them in a game, software application, or simulation. In some embodiments, these modules of activity include one or more (e.g., all) of the following:

1. Initial Visualization & Configuration:

a display screen or series of screens wherein the user initially sets their aspirations from those made available by the system (e.g., system 100 including, for example, appropriate software as part of application 110).

2. Core Game/Sim or Software application:

provides distinct choices and outcomes to the user that affect and/or are affected by the aspirational attributes initially selected by the user. In some embodiments, this module of activity may be enabled by applications 106 and/or 108. In some embodiments, during this period of activity the user may succinctly see the realization or degradation of their aspirational avatar, which was generated as a result of the user's selections during the initial visualization and configuration, while they make choices during use of the game or simulation. Alternatively or additionally, in some embodiments one or more options may be provided for the user to update his/her choices and/or add further definition to them as a means of deepening a user's investment in their aspirational avatar's final depicted state or progress towards aspirational attributes.

3. Final Resolution:

user may conclude game/simulation or application, which can result in achievement or failure to meet planned aspirations. This final state of depiction can make it clear where the user achieved or fell short of their aspirational goals created prior to completion of the user experience.

4. Assessment:

upon resolution of their experience users would be encouraged to reflect on aspirational achievements, or failures, why they occurred, and the consequences of their decisions and actions made during play/use. In some embodiments, this mode allows a user to visually browse the final state of their aspirational avatar and/or to see exactly where their decisions and outcomes from those decisions may have resulted in degradation, realization, and/or surpassing of their goals. In some embodiments, this may provide a direct cause and effect learning experience to the user in a format that attempts to draw parallels between real life and the software user experience.

In some embodiments of the present invention, the initial visualization of the aspirational avatar system involves a graphical user interface (GUI) process that lets users navigate across common life goal categories including, but not limited to, the ones shown in FIG. 2 and/or others (e.g., user's health goals). In some embodiments, initially goals could be roughly defined or defined with more detail depending on the approach a particular embodiment of system 104 (e.g., application 110) would care to take. Various forms of graphical user interface can be provided to guide the choices for the user in a logical fashion (e.g., drop-down menus, check-boxes, etc.). According to another aspect of some embodiments of the present invention, an editor is provided that makes an aspirational attributes configuration motif easy to set up (e.g., to specify available choices and values for the attributes and/or block others) for software developers, or moderators such as classroom teachers, before users (e.g., students) access the configuration module and select their aspirational attributes.

According to some embodiments of the present invention, one or more templates can be provided that guide the presentation of the aspirational attribute choices for users so that the configuration process could be designed to be like a comic book, or appear like a common magazine personality quiz. A third approach according to some embodiments would involve modifying pre-defined choices that offer useful starting or default points from modest, to per-capita average, to above-average aspirational profiles that users could choose from.

In some embodiments, once life goals are set the system and/or methods described herein can render (e.g., generate for immediate and/or subsequent display to the user) key visualizations of the aspirational choices made by the user. For example, visualization templates can include timelines, artistic collages, or structured diagrams. In each layout, computer-executable instructions can be provided that cause the systems and/or methods to provide visual, textual, and/or audio representations of the aspirational model created by the user. In some embodiments, one or more visualizations can be provided that include replacements for the ideal/desired choices made by the user with degraded or otherwise modified (e.g., improved) representations of aspirational choices. Such modified representations can be presented to the user, for example, during and/or subsequent to completion of a game or application wherein choices made by the user affected the ultimate outcomes. As such, in some embodiments, the entire visualization system and/or method can provide a well-rendered representation of a user's current progress in the application/game toward realizing their idealized aspirational outcomes.

According to some embodiments of the present invention, visualization by systems and/or methods provided herein can include the use of silhouettes that fade into view toward idealized form vs. alternative outcomes. For example, in silhouette mode, images (e.g., parts of the user's aspirational avatar) may be depicted within a game or simulation, or after the simulation or game is complete, as silhouettes only, possibly to be filled in during gameplay or thereafter. For example, if the user aspires to have 3 children, 2 boys and 1 girl, the three children may be shown by applications 106 and/or 108 as outlines only until, for example, the user makes the right choices in the game or simulation that would put the user in the position to have the family the user desires. As another example, if the user aspires to be able to care for or interact with a parent, other individual(s), and/or pet(s) in the future, photograph(s) of those individual(s) and/or pets (e.g., photographs uploaded by the user during definition of the user's aspirational attributes) may be shown by applications 106 and/or 108 only partially, out-of-focus, or not at all until, for example, the user makes the right choices in the game or simulation that would put the user in the position to be able to care for or otherwise interact with those individual(s) or pet(s).

Once aspirational attributes (e.g., an aspiration avatar) are defined by the player, in some embodiments the user can then affects its final outcome (e.g., realization or not) through play of a game or simulation or use of an application that requires the user to perform actions and/or make choices.

In some embodiments, the systems and/or methods described herein provide, based on a set of known results, an assessment expressed in positive or negative terms to the user based on what the user achieved in a game, simulation, or application. The user sets the initial (e.g., highest) level of aspiration and the system uses that to generate and store various gradients of modified (e.g., negative) outcomes and stores them for potential use and display to the user to encourage good behavior, or promote behavioral change when necessary.

According to some embodiments, in-game choices are specifically scored and stored (e.g., by applications 106 and/or 108 within a suitable database such as, for example, database 114 or other computer memory) and are tied to specific variables (e.g., specific aspirational attributes selected by the user, such as goals for education). These choices can be communicated, in any suitable form, within system 100 to allow the system to determine which media elements should be provided (e.g., from database 114) for display to the user to depict the user's state and outcome. For example, by standardizing the choices available to users in both the aspirational attributes set up, and during a game or simulation, and defining a relationship between them (e.g., applications 106 and/or 108 registering a given user choice within a game or simulation as being related to one or more aspirational attributes selected by, or available for selection by, the user or categories of aspirational attributes), the system can refer to and process user choices in such a way as to clearly delineate what the user achieved, or did not achieve, as a result of those choices.

For example, in some embodiments, applications 106 and/or 108 may pass one or more values to system 104 (e.g., application 110 or database 114) indicating outcome(s), or user choice(s), that correspond to an aspirational attribute or category of aspirational attributes (e.g., specific attributes selected by the user). In some embodiments, values passed to system 104 may result in either a positive or negative outcome, the values being derived from choices made by the user within the game or simulation provided by applications 106 and/or 108. In one example, the value(s) passed from applications 106 and/or 108 to system 104 may include data indicating that, whereas the user aspired to achieve a certain value corresponding to future wealth (e.g., a “10”), the user's choices in the game or simulation caused the user's future wealth to conclude with a different value (e.g., a “7”). Data stored (e.g., in database 114) may identify the media to display to the user in response to each potential value that can be received from applications 106 and/or 108. In some embodiments, the value(s) passed from applications 106 and/or 108 to system 104 may alternatively or additionally include data indicative of the types of behaviors expressed by the user in the game or simulation (e.g., risky or conservative behavior, good or poor decisions involving family, good or poor decisions involving money or health, etc.), which can also be conveyed to the user as part of the assessment. In some embodiments, application 110 may pass to applications 106 and/or 108 (e.g., before the game or simulation begins) data indicative of the user's aspirational attributes for use by applications 106 and/or 108, for example, to select appropriate scenarios to present to the user and/or as the value to degrade or improve in response to the user's choices during the game or simulation.

In some embodiments, when a user selects an attribute defining that their dream home is an expensive apartment in a big city, the system (e.g., application 110) can generate clear antecedents to that goal with various levels of inferior results such as:
“Due to your risky behavior, you never were able to earn the funds to afford your dream home of an expensive apartment in a big city. Instead, you had to settle for a small apartment in a small town.”
   In some embodiments, each gradient may be ranked in an array of pre-populated results (e.g., stored in database 114). These rankings can then be utilized (e.g., by application 110, and/or applications 106 and/or 108) to adjust outcomes based on values earned or lost by the user during their time with the game, simulation, or application. For example, the above statement may be displayed to a user that took unnecessary or unwise risks within the game or simulation, as reflected by value(s) passed by applications 106 and/or 108 to system 104.

In some embodiments, the systems and/or methods described herein may allow a user to pre-define all aspirational attributes (e.g., aspects of their aspirational avatar), letting choices/gameplay (e.g., via applications 106 and/or 108) decide only the level of outcome toward those goals that they attain. In other embodiments, the systems and/or methods provided herein can allow users to update (e.g., continuously or in specific instances) their aspirational attributes definition during play/use of an application/game. In this mode, players start with rough outlines of their aspirations but through play/use of an application/game they, for example, earn the right to further define and set forth their aspirations as a reward for good play/behavior (e.g., or as a necessity resulting from bad play/behavior).

According to some embodiments, systems and/or methods provided herein can allow a user to further defining his/her aspirational attributes (e.g., aspects of their aspirational avatar) during a game or simulation through the use of labeling. Labeling can involve a user being prompted or otherwise allowed to use further define an aspirational attribute (e.g., particular point of an aspirational avatar model) with a name or other piece of descriptive information or media (e.g., photograph) during and/or upon completion of a game or simulation. For example, during setup, a player may define an aspirational choice of graduating from a university. As the player gets closer to fully realizing that goal through good use/gameplay, the player may be invited to type in, or otherwise select, the name of the school he/she intends to enroll at. Such additional refinement and labeling of choices can further cement the aspiration and simultaneously provide a reward for the player. Other refinements within the labeling context could include, for example, choosing a model of a car or picking a specific exotic vacation spot on a map. In another example, if the user aspires to be able to care for or interact with a parent, other individual(s), and/or pet(s) in the future, the user may be provided with an option to provide (e.g., upload) photograph(s) of those individual(s) and/or pets during and/or upon completion of the game or simulation (e.g., when the user makes the right choices in the game or simulation that would put the user in the position to be able to care for or otherwise interact with those individual(s) or pet(s)).

In some embodiments, the systems and/or methods provided herein can allow the labels to be anything, or in other embodiments may require the user to choose the labels from pre-defined elements (e.g., from a drop-down menu). In some embodiments (e.g., when labels are specified through open-ended response fields), the labels may not be not categorized data that can be perfectly used to perform logical operations. Instead, the initial structure of the aspirational attributes (e.g., avatar) may be used for such efforts by games, simulations, and applications. For example, when a user aspires to graduate from a university, in their life simulation the application might reward them with such progress by asking them to name the university they graduate from. A user might enter or otherwise select Arizona State (e.g., in an open-ended response field, or from a pre-defined list of available schools) or write in University of Mars. The reward of providing further definition can provide further investment by the user in the goal.

In some embodiments, labels defined by the user during in-game play may not affect the final outcome itself nor have to be explicitly referred to in rhetoric displayed to the user. In other embodiments, the labels selected (e.g., from pre-defined elements in, for example, a drop-down menu) can serve as further aspirational attributes used and/or manipulated in an assessment of the user's performance (e.g., degrading one of the user's selected labels to a lesser option or result based at least in part on subsequent bad in-game performance after the user defined the label).

According to some embodiments, the systems and/or methods provided herein may make no distinction between any labels (e.g., real, fantastical, or gibberish) entered or selected by the user and instead may rely on the original category structure for that aspiration when referring to its ultimate outcome to the player. For example, an assessment of the user's performance according to some embodiments of the present invention may include the statement that:
“Your goal of attending a university was derailed by poor grades in your senior year of high school. More emphasis on studying vs. partying may help with achieving that goal.”
   or in a positive framing:
“Your goal of attending and graduating from a university was achieved. Good job navigating acceptance risks like drug use, and poor grades. The university you choose to attend was named University of Mars.”
   In such framing, the label is only an embellishment and does not confuse the player should they choose to not label their choice, or use gibberish when creating the label.

Final resolution of whether the user will attain his/her aspirational attributes can, in some embodiments, involve causing any unresolved elements in the user's progress toward his/her ultimate goals to be projected forward and become fully distinct and clear, or fade away completely. In some embodiments, this stage is reached when the entire simulation has run its course, and the user has reached the end. In some embodiments, there may be no unresolved elements at the end of the simulation (e.g., by design because all of scenarios presented have been designed to fully determine achievement, or not, of the initially-defined aspirational attributes). In some embodiments, if the specific actions and choices taken by the user have not already resolved all the images, a final disposition can be performed (e.g., by application 110 and/or applications 106 and/or 108) based on extrapolating the progress, or lack thereof, the user has made. In some embodiments, the user may be allowed to make interactive choices to refine the ultimate outcome as it becomes fully formed (e.g., due to poor in-game performance, requiring the user to select from one or more degraded options corresponding to one or more of the categories of aspirational attributes initially selected by the user and/or other categories of aspirational attributes).

In some embodiments, once a user has defined aspirational attributes and participated in a computer application, game, or simulation where they have made choices, system 100 may determine that the user's choices have resulted in a differential from their original aspirational profile, thus representing a modified outcome from what the user had originally intended. Systems and/or methods provided herein may thus generate an assessment for the user/player to utilize to encourage the user to reflect upon their choices, as reflection is believed to be a key element of learning design and behavioral change therapy.

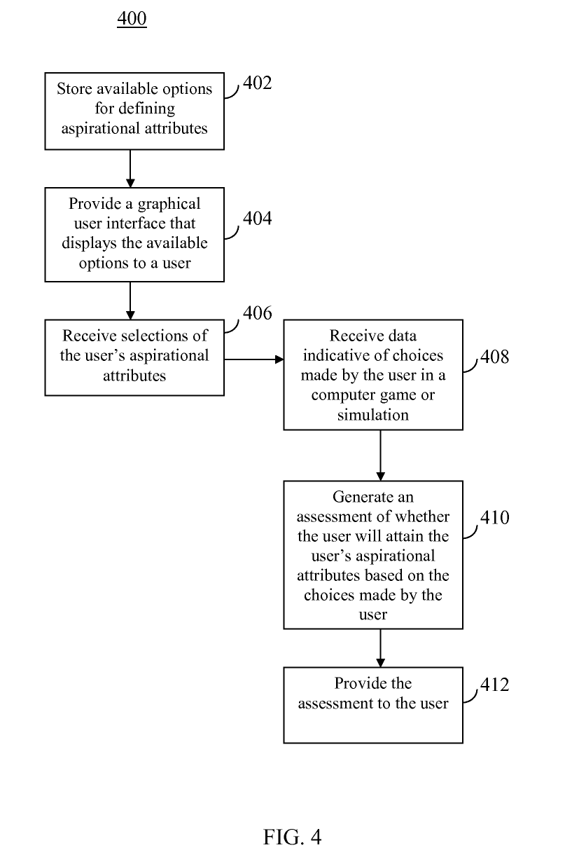

FIG. 4 is a flowchart 400 of illustrative stages involved in assessing behavioral patterns and/or promoting behavioral change according to some embodiments of the present invention. At stage 402, options available to a user to define one or more aspirational attributes relating to the user's future family life, social life, career, education, health, economic status, or other goal for the future may be stored in computer memory (e.g., database 112). At stage 404, a graphical user interface may be provided by a computer system (e.g., application 110) for display to the user, the graphical user interface for displaying the options available to the user to define the user's one or more aspirational attributes. At stage 406, the computer system may receive, based on the user selecting from the one or more options, the user's one or more aspirational attributes relating to the user's future family life, social life, career, education, health, economic status, or other goal for the future. At stage 408, the computer system may receive data relating to one or more choices made by the user within a computer game or simulation, the one or more choices having a defined relationship to the one or more aspirational attributes selected by the user. At stage 410, the computer system may generate an assessment of whether the user will attain (e.g., did attain within the virtual game or simulation or will likely attain in the real world) the user's one or more aspirational attributes based on the choices made by the user within the computer game or simulation. At stage 412, the computer system may provide the assessment (e.g., including video, graphic(s), text, and/or audio) for display to the user.

Thus it is seen that systems and methods are provided for assessing behavioral patterns and promoting behavioral modification by comparing gaming performance to aspirational attributes. Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated and may be pursued in later claims within this or a related application.

Insofar as embodiments of the invention described above are implementable, at least in part, using a computer system, it will be appreciated that a computer program for implementing at least part of the described methods and/or the described systems is envisaged as an aspect of some embodiments of the present invention. The computer system may be any suitable apparatus, system or device, electronic, optical, or a combination thereof. For example, the computer system may be a programmable data processing apparatus, a general purpose computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example, by means of one or more application specific integrated circuits and/or optical elements. Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

What is claimed is:

1. A computer-implemented method for promoting behavioral modification through use of a computer game or simulation, the method comprising:
storing in computer memory options available to a user to define one or more aspirational attributes relating to the user's future family life, social life, career, education, health, economic status, or other goal for the future;
providing by a computer system a graphical user interface for display to the user, the graphical user interface for displaying the options available to the user to define the user's one or more aspirational attributes;
receiving with the computer system, based on the user selecting from the one or more options, the user's one or more aspirational attributes relating to the user's future family life, social life, career, education, health, economic status, or other goal for the future;
receiving with the computer system data relating to one or more choices made by the user within a computer game or simulation, the one or more choices having a defined relationship to the one or more aspirational attributes selected by the user;
generating by the computer system an assessment of whether the user will attain the user's one or more aspirational attributes based on the choices made by the user within the computer game or simulation; and
providing with the computer system the assessment for display to the user.

2. The method of claim 1, wherein the assessment comprises at least one of video, a graphic, text, and audio.

3. The method of claim 1, wherein the assessment comprises an identification of the one or more choices that caused the user to attain, or fail to attain, the user's one or more aspirational attributes.

4. The method of claim 1, wherein the assessment comprises an identification of one or more attributes that are degraded relative to the user's one or more aspirational attributes.

5. The method of claim 1, further comprising storing in computer memory a user profile that includes a value for each of the user's one or more aspirational attributes.

6. The method of claim 5, further comprising providing with the computer system the value for each of the user's one or more aspirational attributes to a computer application that provides the computer game or simulation.

7. The method of claim 6, wherein:
receiving with the computer system data identifying the one or more choices made by the user within a computer game or simulation comprises receiving from the computer application data identifying whether the value for each of the user's one or more aspirational attributes was modified by the computer application based on the choices made by the user within the computer game or simulation; and
generating the assessment by the computer system comprises generating the assessment based on the data received from the computer application.

8. The method of claim 1:
wherein the options available to the user to define the one or more aspirational attributes comprise options to create an avatar; and
further comprising providing with the computer system the avatar for display within the computer game or simulation.

9. The method of claim 8, further comprising altering the display of the avatar within the computer game or simulation based on one or more of the choices made by the user.

10. The method of claim 1, further comprising tailoring one or more scenarios presented to the user within the computer game or simulation based on the user's one or more aspirational attributes.

11. The method of claim 1, further comprising allowing the user to further define the user's one or more aspirational attributes during the computer game or simulation.

12. The method of claim 11, wherein allowing the user to further define the user's one or more aspirational attributes comprises allowing the user to provide a label corresponding to the user's one or more aspirational attributes, wherein the label is provided for display to the user as part of the assessment.

13. A system for promoting behavioral modification through use of a computer game or simulation, the system comprising:
computer memory for storing options available to a user to define one or more aspirational attributes relating to the user's future family life, social life, career, education, health, economic status, or other goal for the future;
a computer system in communication with the computer memory, the computer system configured to:
provide a graphical user interface for display to the user, the graphical user interface for displaying the options available to the user to define the user's one or more aspirational attributes;
receive, based on the user selecting from the one or more options, the user's one or more aspirational attributes relating to the user's future family life, social life, career, education, health, economic status, or other goal for the future;
receive data relating to one or more choices made by the user within a computer game or simulation, the one or more choices having a defined relationship to the one or more aspirational attributes selected by the user;
generate an assessment of whether the user will attain the user's one or more aspirational attributes based on the choices made by the user within the computer game or simulation; and
provide the assessment for display to the user.

14. The system of claim 13:
wherein the computer memory is configured to store a user profile that includes a value for each of the user's one or more aspirational attributes; and
wherein the computer system is further configured to:
provide the value for each of the user's one or more aspirational attributes to a computer application that provides the computer game or simulation;
receive from the computer application data identifying whether the value for each of the user's one or more aspirational attributes was modified by the computer application based on the choices made by the user within the computer game or simulation; and
generate the assessment based on the data received from the computer application.

15. The system of claim 13:
wherein the options available to the user to define the one or more aspirational attributes comprise options to create an avatar; and
wherein the computer system is further configured to provide the avatar to a computer application that provides the computer game or simulation for display within the computer game or simulation.

16. The system of claim 15, further comprising the computer application that provides the computer game or simulation, wherein the computer application is configured to alter the display of the avatar within the computer game or simulation based on one or more of the choices made by the user.

17. The system of claim 13, further comprising a computer application that provides the computer game or simulation, wherein the computer application is configured to tailor one or more scenarios presented to the user within the computer game or simulation based on the user's one or more aspirational attributes.

18. The system of claim 13, further comprising a computer application that provides the computer game or simulation, wherein the computer application is configured to allow the user to further define the user's one or more aspirational attributes during the computer game or simulation by allowing the user to provide a label corresponding to the user's one or more aspirational attributes, wherein the label is provided for display to the user as part of the assessment.

19. A system for promoting behavioral modification through use of a computer game or simulation, the system comprising:
means for storing options available to a user to define one or more aspirational attributes relating to the user's future family life, social life, career, education, health, economic status, or other goal for the future;
means for providing a graphical user interface for display to the user, the graphical user interface for displaying the options available to the user to define the user's one or more aspirational attributes;
means for receiving, based on the user selecting from the one or more options, the user's one or more aspirational attributes relating to the user's future family life, social life, career, education, health, economic status, or other goal for the future;
means for receiving data relating to one or more choices made by the user within a computer game or simulation, the one or more choices having a defined relationship to the one or more aspirational attributes selected by the user;
means for generating an assessment of whether the user will attain the user's one or more aspirational attributes based on the choices made by the user within the computer game or simulation; and
means for providing the assessment for display to the user.

20. A non-transitory computer readable medium comprising computer-executable instructions recorded thereon for causing a computer to perform the method comprising:
storing options available to a user to define one or more aspirational attributes relating to the user's future family life, social life, career, education, health, economic status, or other goal for the future;
providing a graphical user interface for display to the user, the graphical user interface for displaying the options available to the user to define the user's one or more aspirational attributes;
receiving, based on the user selecting from the one or more options, the user's one or more aspirational attributes relating to the user's future family life, social life, career, education, health, economic status, or other goal for the future;
receiving data relating to one or more choices made by the user within a computer game or simulation, the one or more choices having a defined relationship to the one or more aspirational attributes selected by the user;
generating an assessment of whether the user will attain the user's one or more aspirational attributes based on the choices made by the user within the computer game or simulation; and
providing the assessment for display to the user.
